(19) United States
(12) Patent Application Publication
(10) Pub. No.: US 2020/0227816 A1
(43) Pub. Date: Jul. 16, 2020

(54) ANTENNA SYSTEM AND ASSOCIATED RADIATED MODULE

(71) Applicant: MEDIATEK Inc., Hsin-Chu (TW)

(72) Inventors: Shyh-Tirng FANG, Hsin-Chu (TW); Ting-Wei KANG, Hsin-Chu (TW)

(21) Appl. No.: 16/702,672

(22) Filed: Dec. 4, 2019

Related U.S. Application Data
(60) Provisional application No. 62/791,093, filed on Jan. 11, 2019.

(51) Int. Cl. H01Q 1/42; H01Q 1/24

(52) U.S. Cl. CPC H01Q 1/42; H01Q 1/243

(57) ABSTRACT

The present invention provides an antenna system for a user equipment (UE). The antenna system may include a housing of the UE and a radiated module including a first quantity of radiators. The housing may include a second quantity of openings. The radiated module may be arranged to excite the housing for wireless signaling at a target band; at the target band, a performance of the antenna system may be better than a performance of the radiated module alone without the housing.

This application claims the benefit of U.S. provisional application Ser. No. 62/791,093, filed Jan. 11, 2019, the subject matter of which is incorporated herein by reference.

### FIELD OF THE INVENTION

The present invention relates to antenna system and associated radiated module for a user device (UE); more particularly, to antenna system and associated radiated module arranged to excite a housing of the UE for wireless signaling, such that a performance of the antenna system jointly formed by the radiated module and the housing is better than a performance of the radiated module alone without the housing.

### BACKGROUND OF THE INVENTION

FIG. 1 depicts a conventional antenna module 100 for a UE 110. The antenna module 100 integrates one or more antennas 101 into a module to be disposed into a housing 120 of the UE 110. However, the antenna module 100 is designed and optimized as a standalone antenna system by itself in a free space without the housing 120. Therefore, when the antenna module 100 is disposed into the housing 120 for practical use, the housing 120 becomes an impact factor to degrade performance (e.g., radiated power, sensitivity, antenna gain, efficiency, directivity, coverage, return loss, voltage standing wave ratio, etc.) of the antenna module 100. In other words, under conventional design methodology, the performance when the antenna module 100 is actually disposed into the housing 120 will be worse than the performance when the antenna module 100 is alone by itself in free space.

### SUMMARY OF THE INVENTION

An object of the invention is providing an antenna system (e.g., 230 in FIGS. 2a-2b or 3) for a UE (e.g., 210); the antenna system may include a housing (e.g., 220) of the UE and a radiated module (e.g., 200). The radiated module may include a first quantity (e.g., M) of radiators (e.g., r[1] to r[M]) parallel to a plane (e.g., x-y plane in FIG. 2b or 3). The housing may include a conductive portion (e.g., 220a) and a second quantity (e.g., N) of openings (e.g., o[1] to o[N]); at least a segment of an edge of each of the second quantity of openings may be in the conductive portion. The radiated module may be arranged to excite the housing for wireless signaling at a target band; at the target band, a performance of the antenna system may be better than a performance of the radiated module alone without the housing. In an embodiment, a nearest gap (e.g., g1 in FIG. 2b) between a surface (e.g., S2) of the conductive portion and a surface (e.g., S1) of the radiated module may be less than a quarter of a wavelength of the target band.

In an embodiment, on the plane, a projection (e.g., Po[n] in FIG. 2b) of one of the second quantity of openings and a projection (e.g., Pr[m]) of one of the first quantity of radiators may at least partially overlap. In an embodiment, on the plane, a nearest distance (e.g., d[m,n] in FIG. 2b) between a geometric center of a projection (e.g., Po[n]) of one of the second quantity of openings and a geometric center of a projection (e.g., Pr[m]) of one of the first quantity of radiators may be less than a half of a wavelength of the target band. In an embodiment, an angle (e.g., al in FIG. 2b) between a normal (e.g., v2) of a surface (e.g., S2) of the conductive portion and a normal (e.g., v1) of a surface (e.g., S1) of the radiated module may be less than 90 degrees. In an embodiment, the second quantity (e.g., N) may not be less than the first quantity (e.g., M). In an embodiment, on the plane, a total area of projections (e.g., Po[1] to Po[N]) of the second quantity of openings may be less than an area of a projection (e.g., P220) of the radiated module.

In an embodiment, said performance may relate to at least one of the following: radiated performance and impedance matching performance. In an embodiment, said performance may relate to one or more of the following: equivalent isotropically radiated power (EIRP), effective isotropic sensitivity (EIS), total radiated power (TRP), total isotropic sensitivity (TIS), realized antenna array gain, realized antenna gain, equal antenna array efficiency, antenna efficiency, antenna array directivity, antenna directivity, spherical coverage, cumulative distribution function (CDF) of EIRP and peak EIPR. In an embodiment, said performance may relate to one or more of the following: antenna return loss and antenna voltage standing wave ratio (VSWR).

An object of the invention is providing a radiated module (e.g., 200) for a UE (e.g., 210). The radiated module may include a base (e.g., 202) and a first quantity (e.g., M) of radiators (e.g., r[1] to r[M]) on the base; the first quantity of radiators may be arranged to excite a housing (e.g., 220) of the UE to jointly function as an antenna system (e.g., 230) for wireless signaling at a target band; at the target band, a performance of the antenna system may be better than a performance of the radiated module alone.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) depicts a conventional antenna module;

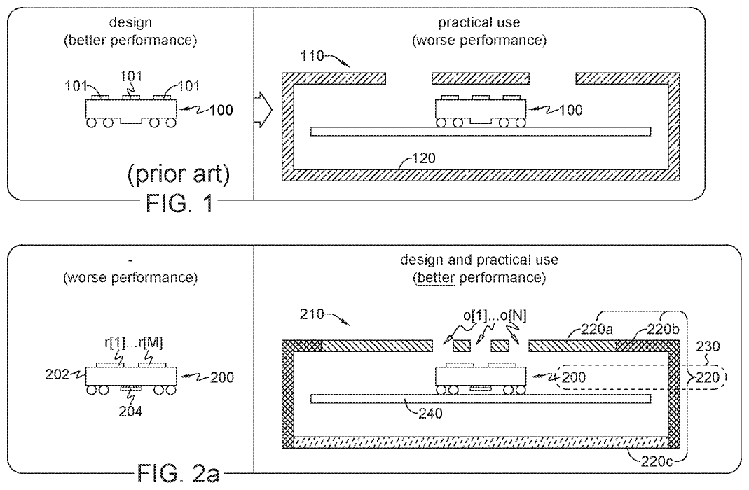

FIGS. 2a and 2b depict conceptual views of an antenna system and associated radiator module according to an embodiment of the invention;

FIG. 3 depicts a conceptual view of the antenna system and associated radiator module according to an embodiment of the invention; and

FIG. 4 compares performances of the radiated module and the antenna system according to an embodiment of the invention.

### DETAILED DESCRIPTION OF PREFERRED EMBODIMENTS

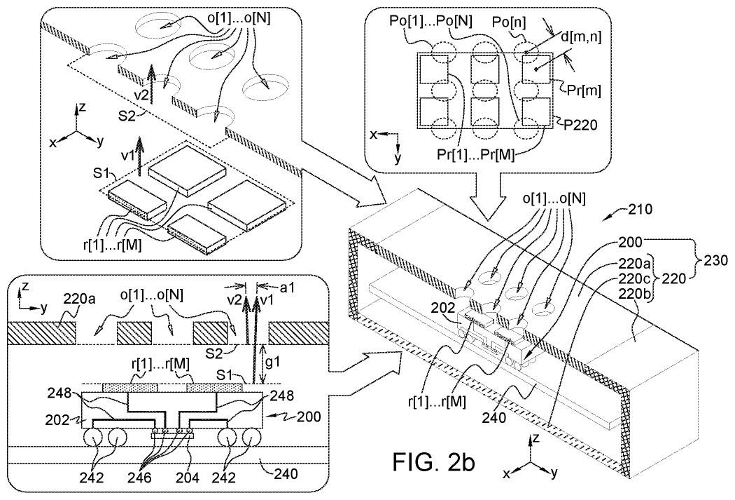

FIGS. 2a to 2b depict conceptual views of an antenna system 230 and associated radiated module 200 for a UE 210 according to an embodiment of the invention. The UE 210 may be a mobile phone, a wearable gadget, a digital camera, a camcorder, a game console, a drone, a sensor element of a sensor network, a mobile Wi-Fi (MiFi) device, a customer premise equipment (CPE), a USB dangle, a fixed-wireless access (FWA), a tablet computer, a laptop computer or any terminal equipment which needs the antenna system 230 to transmit and/or to receive electromagnetic waves at a target band for wireless signaling (e.g., communication).

The UE 210 may include a main board (e.g., a printed circuit board) 240 and a housing (a case) 220 enclosing the main board 240. The radiated module 200 may include a base 202, a semiconductor chip (die) 204 and a quantity M (one or more) of conductive radiators r[1] to r[M] which may be formed on the base 202. According to the invention, the radiated module 200 and the radiators r[1] to r[M] may be arranged (designed, optimized and configured) to excite the housing 220 to jointly function as the antenna system 230 for wireless signaling at the target band, such that, at the target band, a performance of the antenna system 230 may be better than a performance of the radiated module 200 alone without the housing 220. In other words, according to the invention, when designing (and optimizing) the antenna system 230, the housing 220 may have already been considered as a part of the antenna system 230 to jointly function with the radiated module 200; e.g., the radiated module 200 may work as an excitor of the antenna system 230, while the housing 220 may function as an resonating part of the antenna system 230. The radiated module 200 may therefore be designed and optimized along with the housing 220 as in practical use, rather than be designed and optimized alone in a free space without the housing 220. Thus, comparing to the performance achieved by the radiated module 200 alone in free space, the performance achieved when the radiated module 200 is actually disposed in the housing 220 will be better, since the radiated module 200 is not designed to work alone without the housing 220, but is designed to work with the housing 220 as a whole.

The housing 220 may include one or more portions, such as 220a to 220c in the conceptual example in FIGS. 2a and 2b. For example, in an embodiment, the portions 220a and 220c may respectively be a rear cover and a front cover (e.g., a display panel) of the UE 210, and the 220b may be a frame between the portions 220a and 220c. In an embodiment, the portion 220a may be conductive (e.g., be formed by metal), and the radiated module 200 may be disposed on the main board 240 near the conductive portion 220a. Other portions (e.g., 220b and/or 220c) of the housing 220 may be conductive or dielectric. The housing 220 may further include a quantity N (one or more) of openings o[1] to o[N]; a segment of an edge, or the entire edge, of each opening o[n] (for n=1 to N) may be in the conductive portion 220a, For example, in an embodiment, each opening o[1] to o[N] may be in the conductive portion 220a; in another embodiment, the edge of each of a subset (one, some or all) of the openings o[1] to o[N] may have a segment in the conductive portion 220a of the housing 220, and may have another segment in a dielectric portion of the housing 220. Each of the openings o[1] to o[N] may be filled by dielectric material(s), e.g., air, plastic and/or acrylic, etc. In an embodiment, the quantity N may not be less than the quantity M; for example, in an embodiment, the quantities M and N may be equal, and each of the openings o[1] to o[N] may correspond to a respective one of the radiators r[1] to r[M]. In an embodiment, each of the radiators r[1] to r[M] may include one or more microstrips and/or one or more conductive patches formed by one or more mutually insulated conductive layers.

As shown in FIG. 2b, each of the radiators r[1] to r[M] may be parallel to x-y plane; on the x-y plane, the radiators r[1] to r[M] may respectively project to projections Pr[1] to Pr[M], and the openings o[1] to o[N] may respectively project to projections Po[1] to Po[N]. In an embodiment, one of the projections Pr[1] to Pr[M] and one of the projections Po[1] to Po[N] may at least partially overlap. For example, in an embodiment, a projection Pr[m1] of the projections Pr[1] to Pr[M] may only have a portion inside a projection Po[n1] of the projections Po[1] to Po[N], with rest portion left outside; in an embodiment, a projection Po[n2] of the projections Po[1] to Po[N] may only have a portion inside a projection Pr[m2] of the projections Pr[1] to Pr[M], with rest portion left outside; in an embodiment, a projection Pr[m3] of the projections Pr[1] to Pr[M] may be completely inside a projection Po[n3] of the projections Po[1] to Po[N]; and/or, in an embodiment, a projection Po[n4] of the projections Po[1] to Po[N] may be completely inside a projection Pr[m4] of the projections Pr[1] to Pr[M].

As the radiated module 200 and the housing 220 may jointly work for wireless signaling at the target band, in an embodiment, a nearest distance on the x-y plane between a geometric center of one of the projections Po[1] to Po[N] and a geometric center of one of the projections Pr[1] to Pr[M] may be less than a half of a wavelength of the target band; for example, if a projection Pr[m] (for m=1 to M) is nearest to a projection Po[n] among the projections Po[1] to Po[N], than a distance d[m,n] between the geometric centers of the projections Pr[m] and Po[n] may be less than a half of the wavelength of the target band. For example, in an embodiment, the target band may cover band(s) allocated for fifth generation (5G) mobile telecommunication, and the wavelength of the target band may be in a millimeter order ranging from several millimeters to a fraction of one millimeter.

In an embodiment, on the x-y plane, each projection Po[n] (for n=1 to N) may partially or completely overlap with a projection P220 of the radiated module 220; for example, each of a first subset (none, one, some or all) of the projections Po[1] to Po[N] may partially overlap with the projection P220 (i.e., a boundary of each projection of the first subset may intersect a boundary of the projection P220), and/or each of a different second subset (all, some, one or none) of the projections Po[1] to Po[N] may completely fall inside the boundary of the projection P220 to completely overlap with the projection P220. In an embodiment, an area of each projection Po[n] may be smaller than an area of the projection P220. In an embodiment, a total area of the projections Po[1] to Po[N] (i.e., a sum of the areas of the projections Po[1] to Po[N]) may be smaller than the area of the projection P220, It is noted that shapes of the projections Pr[1] to Pr[M] and Po[1] to Po[N] shown in FIG. 2b are merely conceptual for convenience of understanding; in fact, the shape of each projection Pr[m] (for m=1 to M) may not be limited to a rectangle, and the shape of each projection Po[n] (for n=1 to N) may not be limited to an ellipse or a circle. Each of the projections Pr[1] to Pr[M] and Po[1] to Po[N] may be of any shape, such as a shape formed by a combination of union, intersection and/or subtraction of primitive shapes, e.g., line(s), curve(s), triangle(s), rectangle(s), ellipse(s) and/or polygon(s). Shapes of different two of the projections Po[1] to Po[N] may be the same or different, shapes of different two of the projections Pr[1] to Pr[M] may be the same or different, and/or shapes of two projections Pr[m] and Po[n] (for m equal to one of 1 to M and n equal to one of 1 to N) may be the same or different.

In an embodiment, in addition to the radiators r[1] to r[M], the radiated module 220 may further include other conductive element(s) (not shown) to facilitate wireless signaling of the radiators r[1] to M. For example, the radiated module 220 may further include one or more parasitic elements (not shown) to enhance performance (e.g., bandwidth, etc.) of the radiators r[1] to r[M] and the antenna system 230; each parasitic element may be conductive, may be disposed near one or more of the radiators r[1] to r[M], and may be insulated from each of radiators r[1] to r[M].

As shown in FIG. 2b, in an embodiment, a nearest gap g1 between a surface S2 (e.g., a bottom surface) of the conductive portion 220a and a surface S1 (e.g., a top surface of the radiators r[1] to r[M]) of the radiated module 200 may be less than a quarter of the wavelength of the target band. For example, in an embodiment, the gap g1 between the surfaces S1 and S2 may be filled by dielectric material(s) of nonzero thickness, and each of the radiators r[1] to r[M] may therefore be insulated from the conductive portion 220a; the radiators r[1] to r[M] may excite the openings o[1] to o[N] of the conductive portion 220a to function as antennas by non-contact electromagnetic coupling (induction). In another embodiment, the gap g1 may reduce to zero, and a subset (one, some or all) of the radiators r[1] to r[M] may physically contact the conductive portion 220a.

As shown in FIG. 2b, in an embodiment, an angle a1 between a normal v2 of the surface S2 (i.e., a vector perpendicular to the surface S2) of the conductive portion 220a and a normal v1 of the surface S1 of the radiated module 200 may be less than 90 degrees; for example, in an embodiment, the normal v1 and the normal v2 may be substantially parallel with the angle a1 equaling or approximating zero.

As shown in FIG. 2b, besides the base 202, the chip 204 and the radiators r[1] to r[M], the radiated module 200 may further include conductive connectors (e.g., pins or solder balls) 246 connected between the chip 204 and the base 202, as well as conductive connectors (e.g., pins or solder balls) 242 connected between the main board 240 and the base 202. Electric current(s) may flow between the chip 204 and the radiators r[1] to r[M] via a subset (e.g., one or some) of the connectors 246 and a subset (e.g., one or some) of conductive routings 248 inside the base 202; electric current(s) may flow between the chip 204 and the main board 240 via a subset (e.g., one or some) of the connectors 246, a subset (e.g., one or some) of the conductive routings 248 and a subset of the connectors 242. The chip 204 may be a radio frequency integrated circuit (RF IC), and may include circuit(s) such as power amplifier(s) (not shown), etc. In an embodiment, the radiators r[1] to r[M] of the radiated module 200 may form a radiator array parallel to x-y plane, the openings o[1] to o[N] of the conductive portion 220a may form an opening array; under control of the chip 204, the antenna system 230 jointly formed by the radiators r[1] to r[M] of the radiated module 200 and the openings o[1] to o[N] of the conductive portion 220a may function as an antenna array, e.g., a beam-forming antenna array.

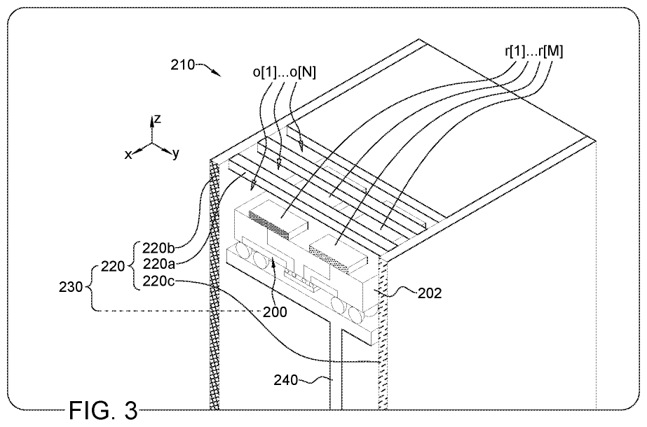

FIG. 3 depicts a conceptual view of the antenna system 230 and the radiated module 200. In this conceptual example, the conductive portion 220a of the housing 220 may be a bezel (or be a section of a bezel) framing around the housing 220, the portions 220b and 220c may be front and rear covers of the housing 220, and each of the openings o[1] to o[N] may shape like a slit extending across two opposite sides of the conductive portion 220a.

As the housing 220 and the conductive portion 220a may have various form factors, shapes and/or sizes for different UEs, the radiated module 200 may be customized along with the housing 220 of each UE to jointly form and optimize the complete antenna system 230, and to cause the antenna system 230 to perform better than the radiated module 200 alone. For example, customizing and optimizing of the antenna system 230 may include tuning one or more of following geometric parameters; locations, shape(s) and/or size(s) (e.g., width and/or length) of each radiator r[m] and/or each opening o[n]; distance(s) between adjacent two of the radiators r[1] to r[M], distance(s) between adjacent two of the openings o[1] to o[N], distance(s) (e.g., d[m,n] in FIG. 2b) between adjacent two projections Pr[m] and Po[n], array formation(s) of the radiator r[1] to r[M] and/or the openings o[1] to o[N] (e.g., in linear array, rectangular array or polar array, etc.), the quantity M, the quantity N, height of the gap g1 (FIG. 2b), etc. In other words, geometry of the radiators r[1] to r[M] and/or the openings o[1] to o[N] may be configured to cause the performance of the antenna system 230 to be better than the performance of the radiated module 200 alone.

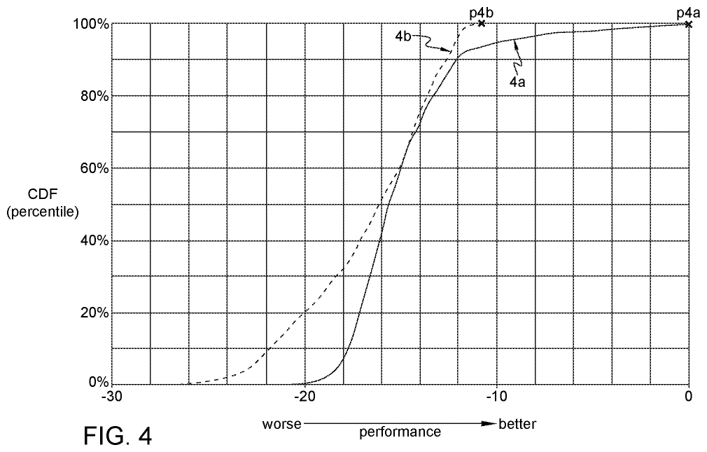

As previously described, based on the invention, the antenna system 230 jointly formed by the housing 220 and the radiated module 200 will perform better than the radiated module 200 alone without the housing 220. In an embodiment, performance may be reflected by CDF of normalized antenna array gain; in FIG. 4, a curve 4a depicts CDF (in percentile) of normalized antenna array gain (in dBi) achieved by the antenna system 230 jointly formed by the housing 220 and the radiated module 200; and a curve 4b depicts CDF of normalized antenna array gain achieved by the radiated module 200 alone without the housing 220. As shown in FIG. 4, because the curve 4a is at right-hand side of the curve 4b, it is understood that the performance of the antenna system 230 jointly formed by the radiated module 200 and the housing 220 is better than the performance of the radiated module 200 alone without the housing 220. Performances of the antenna system 230 and the radiated module 200 may also be reflected by peak values p4a and p4b of the curves 4a and 4b respectively; again, as shown in FIG. 4, the performance of the antenna system 230 is better than the performance of the radiated module 200 since the peak value p4a is greater than the peak p4b. In general, to evaluate and compare performances of the antenna system 230 and the radiated module 200, said performance may relate to radiated performance, impedance matching performance or a combination (e.g., a weighted sum) of the radiated performance and the impedance matching performance. The radiated performance may relate to one or more of the following (e.g., may be one of the following or may be derived from one or more of the following, such as a weighted sum of more than one of the following): EIRP, EIS, TRP, TIS, realized antenna array gain, realized antenna gain, equal antenna array efficiency, antenna efficiency, antenna array directivity, antenna directivity, spherical coverage, CDF of EIRP and peak EIPR, etc. The impedance matching performance may relate to one or more of the following: antenna return loss and antenna VSWR, etc.

To sum up, comparing to convention antenna module which is designed and optimized in free space without housing and hence suffers performance degrade when disposed in housing for practical use, the radiated module according to the invention may be designed and optimized along with housing as in practical use, so the antenna system jointly formed by the radiated module and the housing may perform better than the radiated module alone without the housing, and may better satisfy demands of practical use.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An antenna system for a user equipment (UE), comprising:
a housing of the UE; and
a radiated module comprising a first quantity of radiators; wherein:
the housing comprises a second quantity of openings;
the radiated module is arranged to excite the housing for wireless signaling at a target band; and
at the target band, a performance of the antenna system is better than a performance of the radiated module alone without the housing.

2. The antenna system of claim 1, wherein:
each of the first quantity of radiators is parallel to a plane;
on the plane, a projection of one of the second quantity of openings and a projection of one of the first quantity of radiators at least partially overlap.

3. The antenna system of claim 1, wherein:
the housing further comprises a conductive portion;
at least a segment of an edge of each of the second quantity of openings is in the conductive portion;
a nearest gap between a surface of the conductive portion and a surface of the radiated module is less than a quarter of a wavelength of the target band.

4. The antenna system of claim 1, wherein:
each of the first quantity of radiators is parallel to a plane;
on the plane, a nearest distance between a geometric center of a projection of one of the second quantity of openings and a geometric center of a projection of one of the first quantity of radiators is less than a half of a wavelength of the target band.

5. The antenna system of claim 1, wherein:
the housing further comprises a conductive portion;
at least a segment of an edge of each of the second quantity of openings is in the conductive portion;
an angle between a normal of a surface of the conductive portion and a normal of a surface of the radiated module is less than 90 degrees.

6. The antenna system of claim 1, wherein the second quantity is not less than the first quantity.

7. The antenna system of claim 1, wherein:
each of the first quantity of radiators is parallel to a plane;
on the plane, a total area of projections of the second quantity of openings is less than an area of a projection of the radiated module.

8. The antenna system of claim 1, wherein said performance relates to at least one of the following: radiated performance and impedance matching performance.

9. The antenna system of claim 1, wherein said performance relates to one or more of the following: equivalent isotropically radiated power (EIRP), effective isotropic sensitivity (EIS), total radiated power (TRP), total isotropic sensitivity (TIS), realized antenna array gain, realized antenna gain, equal antenna array efficiency, antenna efficiency, antenna array directivity, antenna directivity, spherical coverage, cumulative distribution function (CDF) of EIRP and peak EIPR.

10. The antenna system of claim 1, wherein said performance relates to one or more of the following: antenna return loss and antenna voltage standing wave ratio (VSWR).

11. An antenna system for a user equipment (UE), comprising:
a housing of the UE; and
a radiated module comprising a first quantity of radiators parallel to a plane; wherein:
the housing comprises a second quantity of openings;
the radiated module is arranged to excite the housing for wireless signaling at a target band; and
on the plane, a total area of projections of the second quantity of openings is less than an area of a projection of the radiated module.

12. The antenna system of claim 11, wherein:
the housing further comprises a conductive portion;
at least a segment of an edge of each of the second quantity of openings is in the conductive portion;
a nearest gap between a surface of the conductive portion and a surface of the radiated module is less than a quarter of a wavelength of the target band.

13. The antenna system of claim 11, wherein:
at the target band, a performance of the antenna system is better than a performance of the radiated module alone without the housing.

14. A radiated module for a UE, comprising:
a base; and
a first quantity of radiators on the base parallel to a plane, arranged to excite a housing of the UE to jointly function as an antenna system for wireless signaling at a target band, wherein:
the housing comprises a second quantity of openings; and
on the plane, a total area of projections of the second quantity of openings is less than an area of a projection of the radiated module.

15. The radiated module of claim 14, wherein:
the housing further comprises a conductive portion;
at least a segment of an edge of each of the second quantity of openings is in the conductive portion; and
a nearest gap between a surface of the conductive portion and a surface of the radiated module is less than a quarter of a wavelength of said wireless signaling.

16. The radiated module of claim 14, wherein:
on the plane, a nearest distance between a geometric center of the projection of one of the second quantity of openings and a geometric center of the projection of one of the first quantity of radiators is less than a half of a wavelength of said wireless signaling.

17. The radiated module of claim 14, wherein:
the housing further comprises a conductive portion;
at least a segment of an edge of each of the second quantity of openings is in the conductive portion; and
an angle between a normal of a surface of the conductive portion and a normal of a surface of the radiated module is less than 90 degrees.

18. The radiated module of claim 14, wherein the second quantity is not less than the first quantity.

19. The radiated module of claim 14, wherein:
at the target band, a performance of the antenna system is better than a performance of the radiated module alone without the housing.

20. The radiated module of claim 19, wherein said performance relates to one or more of the following: EIRP, EIS TRP, TIS, realized antenna array gain, realized antenna gain, equal antenna array efficiency, antenna efficiency, antenna array directivity, antenna directivity, spherical coverage, cumulative distribution function of EIRP, peak EIPR, antenna return loss and antenna VSWR.
